(19) United States
(12) Patent Application Publication
(10) Pub. No.: US 2005/0013133 A1
(43) Pub. Date: Jan. 20, 2005

(54) Lamp with a capability of concentrating light

(76) Inventor: Peter Yeh, Tainan Hsien (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/620,425

(22) Filed: Jul. 17, 2003

(51) Int. Cl. F21V 21/00

(52) U.S. Cl. 362/235; 362/249; 362/351

(57) ABSTRACT

A lamp that can concentrate light has two brackets, two shade holders, a shade, two sockets and two illuminating elements. The shade holders are attached respectively to the brackets. The shade is mounted between the shade holders and has a tubular body, a slit and an extension. The tubular body is made of an opaque material and is attached to the shade holders. The slit is longitudinally defined through the tubular body. The extension extends from the tubular body along the slit. The sockets are respectively mounted on the shade holders. The illuminating elements are attached to the sockets and are mounted in the open ends of the tubular body of the shade. Accordingly, the light emitting from the illuminating elements is concentrated and emits only from the slit in the shade to increase the brightness of the light emitted from the lamp.

### BACKGROUND OF THE INVENTION

1. Field of the Invention

The present invention relates to a lamp, and more particularly to a lamp that can concentrate light to enhance the brightness provided by the lamp.

2. Description of Related Art

A lamp is usually mounted on a wall or an object, such as a backrest of a seat or a ceiling in a vehicle or an airplane to provide illumination for a user. A conventional lamp in accordance with the prior art substantially comprises a base, an illuminating element and a shade. The illuminating element is mounted on the base and is electrically connected to a power source. The shade is mounted on the base and is mounted around the illuminating element. The shade is made of a material pervious to light emitting from the illuminating element.

However, because the shade of a conventional lamp is made of a material pervious to light, the light will disperse when it passes through the shade. The light emitted from a conventional lamp is not concentrated so the illumination provided by a conventional lamp is not bright enough.

To overcome the shortcomings, the present invention provides a lamp to mitigate or obviate the aforementioned problems.

### SUMMARY OF THE INVENTION

The main objective of the invention is to provide a lamp that concentrates light to increase the brightness of the light emitted from the lamp.

The lamp has two brackets, two shade holders, a shade, two sockets and two illuminating elements. The shade holders are attached respectively to the brackets. The shade is mounted between the shade holders and has a tubular body, a slit and an extension. The tubular body is made of an opaque material and has an axis and two open ends attached respectively to the shade holders. The slit is longitudinally defined through the tubular body along the axis. The extension extends from the tubular body along the slit. The sockets are mounted respectively on the shade holders. The illuminating elements are attached to the sockets and are mounted in the open ends of the tubular body of the shade. In such an arrangement, light emitted from the illuminating elements is concentrated and emits only from the slit in the shade. Accordingly, the brightness of the light emitted from the lamp is increased.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a lamp in accordance with the present invention;

FIG. 2 is an exploded perspective view of the lamp in FIG. 1;

FIG. 3 is an enlarged exploded perspective view of parts of the lamp in FIG. 2;

FIG. 4 is a cross sectional side plan view of the lamp in FIG. 1; and

FIG. 5 is an operational cross sectional side plan view of the lamp in FIG. 1.

### DETAILED DESCRIPTION OF PREFERRED EMBODIMENT

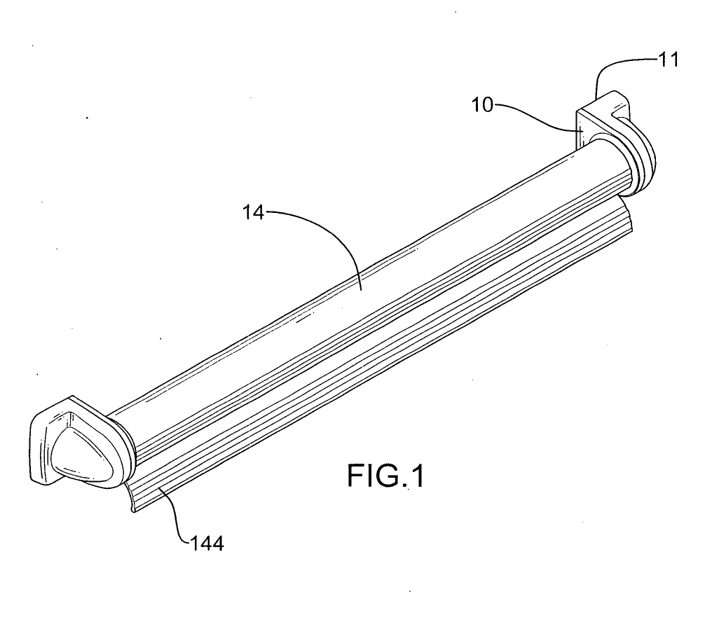

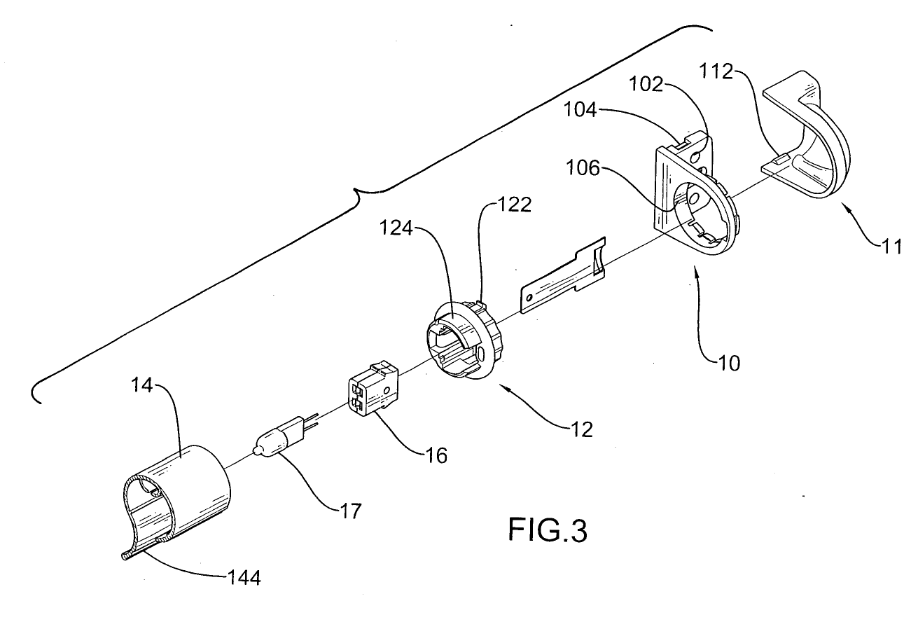

With reference to FIGS. 1 to 3, a lamp in accordance with the present invention comprises two brackets (10), two shade holders (12), a shade (14), two sockets (16), two illuminating elements (17) and optionally two end caps (11). Each bracket (10) is L-shaped and has a first side (not numbered) and a second side (not numbered) with a mounting hole (106). The first side of each respective bracket (10) has multiple through holes (102). Multiple fasteners (not shown) respectively penetrate the through holes (102) to secure the bracket (10) to an object such as a wall, a ceiling of a vehicle or a backrest of a seat. The mounting hole (106) is defined through the second side of each bracket (10).

The shade holders (12) are attached respectively to the brackets (10). Each shade holder (12) has a distal end (not numbered) and a proximal end (not numbered). The proximal ends of the shade holders (12) are inserted respectively into the mounting holes (106) in the brackets (10). Each shade holder (12) optionally has multiple hooks (122) formed on the proximal end to engage the second side of the corresponding bracket (10). With the engagements between the hooks (122) on the shade holder (12) and the second side of the bracket (10), each shade holder (12) is securely attached to the corresponding bracket (10). In another embodiment, the proximal end of the shade holder (12) is pressed into the mounting hole (106) or is attached with glue. Optionally, the distal end of each shade holder (12) has a flange (124) that extends longitudinally from the distal end of the shade holder (12) and has an outer diameter (not shown).

The shade (14) is mounted between the shade holders (12) and comprises a tubular body (not numbered), a slit (142) and an extension (144). The tubular body is made of an opaque material such as metal. The tubular body has an axis (not shown), a length (not numbered), a cross section (not numbered) and two open ends (not numbered). The open ends of the tubular body are attached respectively to the distal ends of the shade holders (12). Where the distal end of each shade holder (12) has a flange (124), a corresponding open end of the tubular body of the shade (14) is mounted on the flange (124). The cross section of the tubular body is circular so the open ends are circular and correspond to the annular flanges (124) on the shade holders (12). The open ends of the tubular body have an inner diameter (not shown) slightly smaller than the outer diameter of the flanges (124) on the shade holders (12). Accordingly, the open ends of the tubular body are pressed respectively onto the flanges (124) on the shade holders (12) to rotatably mount the shade (14) between the shade holders (12).

The slit (142) is defined through the tubular body (14). Optionally, the slit (142) is longitudinally defined through the tubular body (14) parallel to the axis and extends from one open end to the other. In another embodiment, the slit (142) is shorter than the length of the tubular body. The extension (144) extends from the tubular body along the slit (142).

The sockets (16) are mounted respectively in the shade holders (12) and are electrically connected to a power source (not shown). Each shade holder (12) has a recess (not numbered) defined in the distal end to hold the corresponding socket (16). The illuminating elements (17) are mounted respectively in the sockets (16) and are mounted respectively in the open ends of the tubular body of the shade (14). Optionally, the illuminating elements (17) are LEDs (light emitting diodes).

The end caps (11) are attached respectively to the brackets (10) to provide a decorative effect to the lamp. Each bracket (10) has multiple engaging recesses (104) defined in the first side of the bracket (10). Each end cap (11) has multiple protrusions (112) to respectively engage the engaging recesses (104) in the corresponding bracket (10). With the engagement of the protrusions (112) and engaging recesses (104), the end caps (11) are securely attached to the corresponding brackets (10).

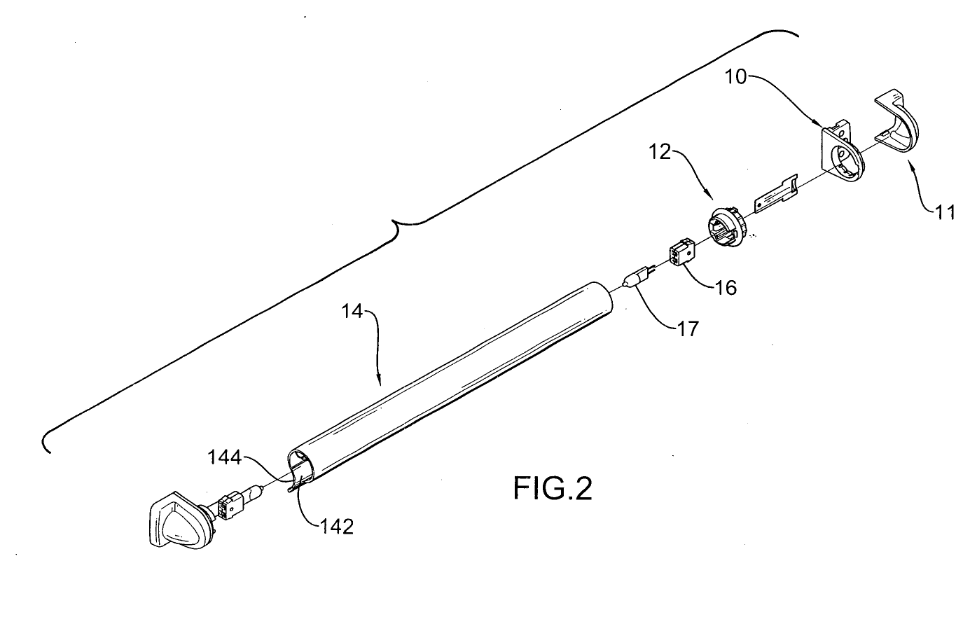

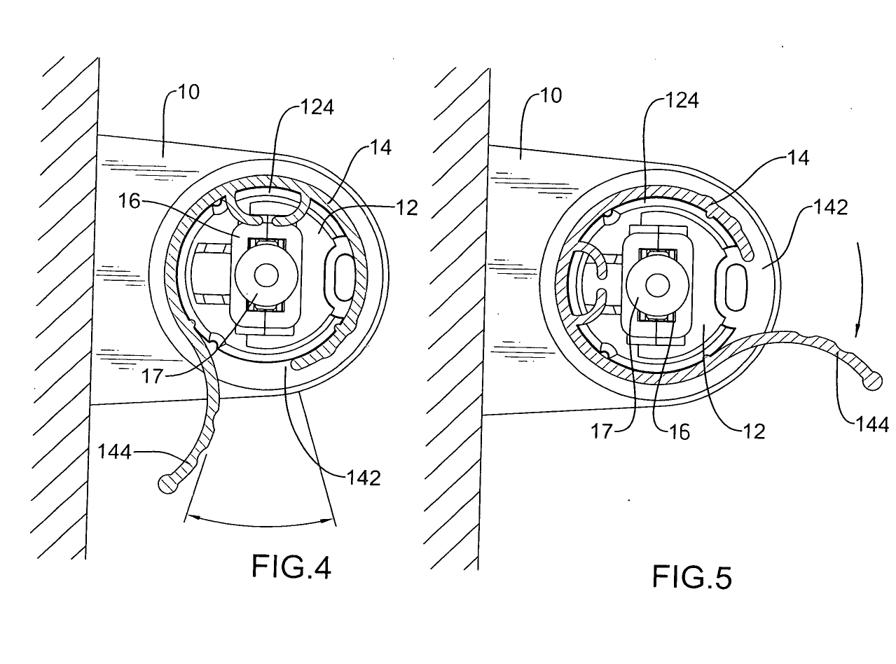

With reference to FIGS. 2, 4 and 5, the light emitted from the illuminating elements (17) when the illuminating elements (17) are on is emitted from the shade (14) only through the slit (142) because the tubular body of the shade (14) is made of an opaque material. This concentrates the light and increases the brightness of the light provided by the lamp. In addition, the light emitted from the slit (142) in the shade (14) is further limited to a desired direction by the extension (144). Consequently, the brightness of the light emitted from the lamp is improved.

Furthermore, the slit (142) in the shade (14) can be rotated to any desired angle to meet different user's need since the shade (14) is rotatably attached to the shade holders (12). The use of the lamp in accordance with the present invention is versatile.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A lamp comprising:
two brackets;
two shade holders attached respectively to the brackets;
a shade mounted between the shade holders and comprising:
a tubular body made of an opaque material and having an axis and two open ends attached respectively to the shade holders;
a slit defined through the tubular body; and
an extension extending from the tubular body along the slit; and
a socket with an illuminating element attached to each shade holder, and the illuminating element mounted in a corresponding one of the open ends of the tubular body of the shade.

2. The lamp as claimed in claim 1, wherein each bracket is L-shaped and has a first side and a second side with a mounting hole defined through the second side for mounting a corresponding one of the shade holders in the mounting hole; and
each shade holder has a distal end and a proximal end inserted into the mounting hole in a corresponding one of the brackets and multiple hooks formed on the proximal end to engage the second side of the corresponding bracket.

3. The lamp as claimed in claim 2, wherein each shade holder has a longitudinal flange with an outer diameter formed on the distal end of the shade holder; and
the tubular body of the shade has a circular cross section to make the open ends circular and having an inner diameter,
wherein the inner diameter of the circular open end of the shade is slightly smaller than the outer diameter of the flange on a corresponding one of the shade holders to rotatably mount each open end of the shade on the flange on the corresponding shade holder.

4. The lamp as claimed in claim 2, wherein each bracket has multiple through holes defined through the first side of the bracket for multiple fasteners to respectively penetrate the through holes to attach the bracket to an object.

5. The lamp as claimed in claim 2 further comprising two end caps attached respectively to the brackets.

6. The lamp as claimed in claim 5, wherein each bracket has multiple engaging recesses defined in the first side of the bracket; and
each end cap has multiple protrusions to engage respectively the engaging recesses in a corresponding one of the brackets.

7. The lamp as claimed in claim 1, wherein the slit is longitudinally defined through the tubular body along the axis.

8. The lamp as claimed in claim 7, wherein the slit extends from one open end to the other.
